(19) United States
(12) Patent Application Publication
(10) Pub. No.: US 2012/0101876 A1
(43) Pub. Date: Apr. 26, 2012

(54) METHOD OF MANAGING HOUSEHOLD PRODUCT INVENTORY

(75) Inventors: Robert R. Turvey, Sanford, MI (US); Jose Porchia, Greenfield, WI (US); Rishabh Singh, Milwaukee, WI (US); Imtiaz A. Musaliar, Racine, WI (US); Rox-Anne R. Klemetsen, Franklin, WI (US)

(73) Assignee: S. C. Johnson, Inc., Racine, WI (US)

(21) Appl. No.: 13/276,984

(22) Filed: Oct. 19, 2011

Related U.S. Application Data
(60) Provisional application No. 61/344,838, filed on Oct. 21, 2010.

(51) Int. Cl. G06Q 30/02; G06Q 40/00; G06F 17/30

(52) U.S. Cl. 705/14.1; 707/748; 705/35; 707/736; 707/E17.044

(57) ABSTRACT

A method of managing an inventory of household products through virtual storage, such as in a virtual refrigerator, freezer, pantry, using electronic devices such as a smart phone. The virtual storage includes at least one of a description of each product in the virtual storage; the date each product was purchased; the expiration date of each product; and the freshness level of each product, including whether each product is still fresh, needs to be used within a certain time period, or needs to be thrown out. Related features include generation of shopping lists, coupons and recipes for a consumer based on the products in virtual storage or depleted therefrom.

### CROSS-REFERENCE TO RELATED APPLICATION

This application claims priority to U.S. Provisional Patent Application No. 61/344,838 filed Oct. 21, 2010, which is incorporated herein by reference.

### FIELD OF INVENTION

The present disclosure relates to a method of managing an inventory of household products, including virtual storage of such products in a virtual refrigerator, freezer, pantry, etc. More particularly, the present disclosure is directed to a method for managing an inventory of household products using at least one electronic device, such as a scanner, a computer, a smart phone, a personal digital assistant (PDA) and the like.

### BACKGROUND OF THE INVENTION

Many people loose track of what is in their refrigerator, freezer, pantry and other storage locations in their household such as by items getting pushed to the back or hidden by other items in these locations. As a result, products are forgotten, the products expire and then simply thrown away. This is a waste of the product and the money spent on these items.

As people use products in their household, many people make shopping lists of the products that need to be replaced and additional products that are wanted or needed. This helps make grocery shopping a more productive use of one's time. However, upon returning home from the store, people often realize that one or more products have been forgotten. This ends up wasting the person's time since another trip to the store is needed to purchase the forgotten product(s). Further, a person may purchase a particular product while grocery shopping only to realize upon returning home that they already had that product, but had forgotten that the product was in their household inventory. This also ends up wasting the person's time and money in purchasing the unnecessary product. Also, if the product is seldom used by the person, the product will need to be stored by the person and may expire before being used. This again is a waste of the person's time, money and storage space.

Further, while at the grocery store a person may not purchase a particular product knowing that the product is in their household inventory in their refrigerator, freezer or pantry. However, when the person goes to use the particular product, the person may discover that the product has already expired and must be thrown out. This too is a waste of the person's money since the expired product must be thrown out and a waste of the person's time by having to make an additional trip to the grocery store for that product.

Also, people spend valuable time making shopping lists, grocery shopping, planning meals, clipping coupons, looking for sales on products, keeping records for budgetary or other financial purposes, and managing one's diet and health. This time could be spent on other activities if the shopper had a more efficient manner of compiling grocery lists, grocery shopping, planning meals, obtaining coupons for products used in their household, maintaining receipt records, and managing food consumption.

### SUMMARY OF INVENTION

In view of the above, there is a need in the market for a method of managing an inventory of household products in a virtual storage, e.g., a virtual refrigerator, freezer and pantry, in a person's household. This would enable the person to know what products they have, what products are needed, and the status of such products. The person could also quickly and easily compile shopping lists, plan meals, obtain coupons, pull up receipt records, manage food consumption, and accomplish nutritional goals. These things could be done at any time, even while the person is in the grocery store. The method or system also allows for participation by multiple people, including from different locations.

The present disclosure is directed to a method of managing an inventory of household products which includes virtual storage, e.g., in a virtual refrigerator, freezer, pantry, etc., which corresponds to actual products in a consumer's refrigerator, freezer, pantry, etc. More particularly, the disclosure is directed to managing the inventory of household products using at least one electronic device, such as a scanner, a computer, a smart phone, a personal digital assistant (PDA) and the like.

The present method of managing household product inventory provides a consumer with an inventory of products in their household and information about these products. This information includes a description of the products; the storage location of the product, e.g., the consumer's refrigerator, freezer, pantry or other household storage area; the date the products were purchased; the cost of the products purchased; the expiration date of the products; and the freshness level of the products based on age and manner of storage, including whether the products are still fresh, need to be used within a certain time period, or need to be thrown out. The consumer may customize, access and update this household product inventory information using any electronic device containing, or having access to, an electronic application of the present disclosure. As such, a consumer does not need to actually look in their refrigerator, freezer, pantry or other storage area(s) to know what products are there and what products are needed.

Each product located in the consumer's actual household storage, e.g., refrigerator, freezer, pantry, etc., is in the consumer's virtual storage and is organized into real time listings displayed upon and according to the consumer's request. The consumer can utilize this information to automatically generate shopping lists, check their household product inventory such as when they are at a store, obtain coupons for various products, plan meals, know what products to use or throw out based on the calculated freshness level, track and manage diet and food consumption, track grocery expenses and shopping history.

It should be appreciated that the present technology can be implemented and utilized in numerous ways, including without limitation as a process, an apparatus, a system, a device, a method for applications now known and later developed or a computer readable medium. The different embodiments of the disclosure will be apparent from the following description of the preferred embodiments and from the accompanying drawings.

### BRIEF DESCRIPTION OF THE DRAWINGS

The following detailed description of specific non-limiting embodiments of the present invention can be best understood when read in conjunction with the following drawings, where like structures are indicated with like reference numbers.

FIG. 1 illustrates primary aspects of the method of the present disclosure.

FIG. 2 is a front view of an inside of a conventional refrigerator with various products therein.

FIG. 3 is an example of a freshness levels shown in screen outputs of an electronic application of the method for products in a consumer's virtual storage.

FIG. 4 illustrates an embodiment of a storage display of household products, including their status, in a consumer's virtual storage using the subject technology.

FIG. 5 illustrates steps for adding a product to a consumer's virtual storage database.

FIG. 6 illustrates steps for adding products, with and without barcodes, to the household inventory in the virtual storage using the subject technology.

FIG. 7 illustrates an alternative display of data, i.e., a picture of a product, with selected product information, in the virtual storage using the subject technology.

FIGS. 8A-8E illustrate examples of different output displays for various features of the subject technology.

FIG. 9 illustrates various elements that can be incorporated in the system of the subject technology, including entry of data into the system, and manipulation of data stored, such as to generate a shopping list or obtain manufacturer coupons.

### DETAILED DESCRIPTION OF PREFERRED EMBODIMENTS

The present disclosure overcomes many of the prior art problems associated with household inventory. The advantages, and other features of the methods and systems disclosed herein, will become more readily apparent to those having ordinary skill in the art from the following detailed description of certain preferred embodiments taken in conjunction with the drawings which set forth representative embodiments of the present technology.

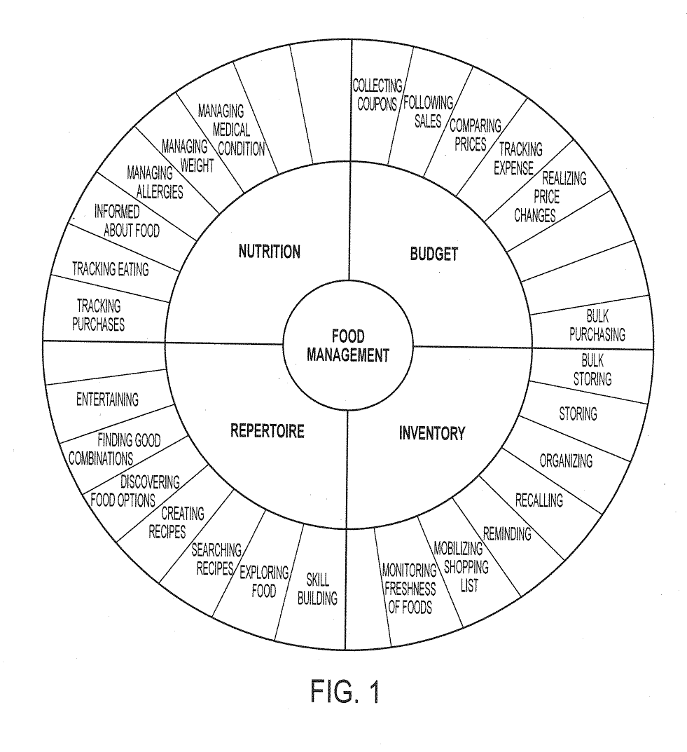

Referring to FIGS. 1-9, the method of the disclosure involves use of at least one electronic device, such as a consumer's personal computer, smart phone, PDA or other electronic device with data storage capability or ability to access stored data, either locally or remotely through connection to another device, to enable the consumer to manage an inventory of household products, such as products in a refrigerator, freezer, pantry and/or other household storage location, through virtual household storage.

For convenience of description, the subject technology will be described in relation to a “consumer”. “Consumer” is understood herein to be one or more individuals. One advantage of the management method of the present disclosure is that a system is provided which allows for participation by multiple individuals as is further described below. This management method enables the consumer to create and access a list of products in the consumer's inventory with a local or mobile device, e.g., smart phone, PDA, computer, etc. As such, the status of products (e.g. presence or absence in inventory, freshness, manner of storage, etc.) can be determined; shopping lists can be readily generated; and the consumer can shop for products at any time without pre-planning and without a paper shopping list since the inventory and status of products therein, etc. are readily accessible.

Further, the method integrates various other features with the management of inventory, such as generation of shopping lists, obtaining coupons for desired products, and accessing and/or maintaining recipes in one location and correlating with inventory storage to determine the presence of items for the recipe in inventory or to generate a shopping list for items not in inventory. This saves the consumer time and money in not having to manually compile or locate such items. The consumer can also search for recipes that correspond to their time, skill and ingredients as present in their household inventory. Still further, the method enables the consumer to track and manage food purchases over time to manage longer term goals associated with diet, health and budget requirements. Also, family members can stay in sync with each other for shopping, cooking and managing the household inventory since the household inventory and shopping lists are updated in real-time. These and other aspects of the subject technology are described in greater detail hereafter.

The method of the disclosure enables the consumer to manage and organize various aspects of the consumer's household as shown for example in FIG. 1. These aspects may generally be organized into categories as follows: (1) inventory; (2) budget; (3) repertoire; and (4) nutrition. The “inventory” category includes tasks associated with acquiring groceries including making shopping lists, tracking products consumed at home, storing and organizing the household products, recalling and reminding the consumer what is in their inventory and monitoring the freshness of the products in their inventory.

The “budget” category includes tasks associated with managing the financial aspects of food including collecting coupons, shopping in multiple stores, buying in bulk, tracking sales, looking for online discounts, comparing item prices, tracking expenses and monitoring price changes of products in their household inventory.

The “repertoire” category includes tasks associated with extending one's food repertoire including exploring foods which are not commonly utilized by the particular consumer, searching for new recipes, creating recipes, discovering food options and alternatives based on people's tastes, finding good combinations of foods and preparing meals for a large group or preparing multiple meals during a predetermined time period without having to make multiple trips to the grocery store.

The “nutrition” category includes tasks associated with understanding the content of food and controlling diet including tracking purchases and nutritional content thereof, tracking eating habits, providing nutritional information about food in the household inventory, managing allergies, managing weight loss and managing medical conditions. These aspects of the subject technology are set forth hereafter in greater detail.

### Inventory Category

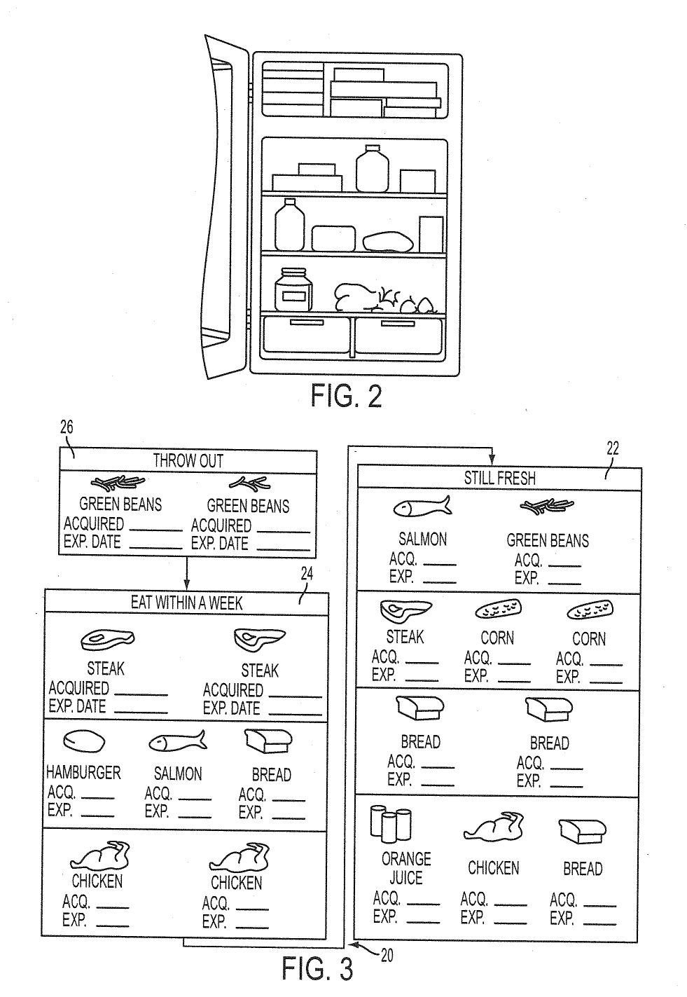

The method of managing a household product inventory provides the consumer with a product inventory and information about the products in the consumer's household product inventory. In a conventional physical refrigerator and freezer as shown in FIG. 2, to determine what is there, items need to be looked through and viewed. The length of time the item has been present may or may not be determinable even upon viewing the item. The unpleasant task of sniffing items or opening closed items is often required. In the method of the subject technology involving virtual storage, this will not be required. A simple review of the virtual storage records will provide the necessary information allowing appropriate action to be taken.

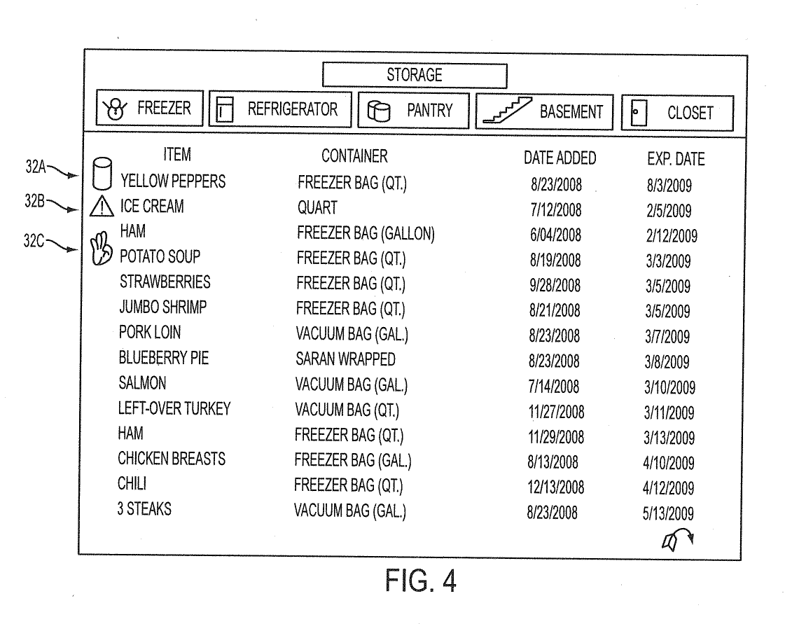

With reference to FIG. 3, such information is sorted based on the method and displayed according to a freshness level indicator 20 which includes the freshness level of the products, including whether the products are still fresh, need to be used or need to be thrown out. Such displays can be as separate displays or screens or, alternatively, as a single scrolling display. The example in FIG. 3 includes different categories based on freshness level wherein each item is represented by a photo thereof and the acquired date and expiration date set forth. Further, alternate displays or screens are available depending on the sort of information a consumer desires. For example, an alternate display would be as shown in FIG. 4 wherein the system of the method displays descriptions of the products in the consumer's household storage based on location where the products are stored, e.g., in the refrigerator, freezer, pantry, basement or closet; item description; manner of storage; the date the products were purchased; and the expiration date of the products. FIG. 4 is further described below. With respect to FIG. 3, the freshness level indicators 20 are arranged based on categories which include “still fresh” 22; “eat within a week” 24; and “throw out” 26. The products in the “still fresh” 22 category are fresh and not near the expiration date. The products in the “eat within a week” 24 category are to be used within a week, e.g., a predetermined time period which can be a pre-set time by the system or selected by the consumer, since those products are close to their expiration date and will soon pass their expiration date if not used. The products in the “throw out” 26 category have reached or are past their expiration date. Accordingly, the method of the present disclosure manages the products in the consumer's household storage and tracks and sorts the products for placement in one of these predetermined categories, or other categories as desired by the user, depending on a calculation between the acquired date and the expiration date of the product. This calculation is performed at predetermined time intervals, such as daily, to determine in which category the products should be listed. Accordingly, the results thereof are updated upon each calculation and the displays will change in real time.

The consumer may access and update the product information using any electronic device containing the system, such as through an application or “app”; or a device linked with the electronic device containing the application. As such, a consumer does not need to be looking in the physical refrigerator, freezer, pantry or the like to know what products they have or what products are needed. Each product added to the system is organized based on the management method into listings predetermined and modifiable automatically based on system parameters or by new user input due to change in circumstances and subject to display to the consumer upon request to show real time status of the products. The products may be listed and described generally or with specific details including such things as brand, style, quantity, size, etc.

Accordingly, the consumer can utilize this product information to at least make shopping lists, check their household product inventory at any time, obtain coupons for various products, create recipes, obtain product freshness levels, track expenses, track nutrition information and manage food intake.

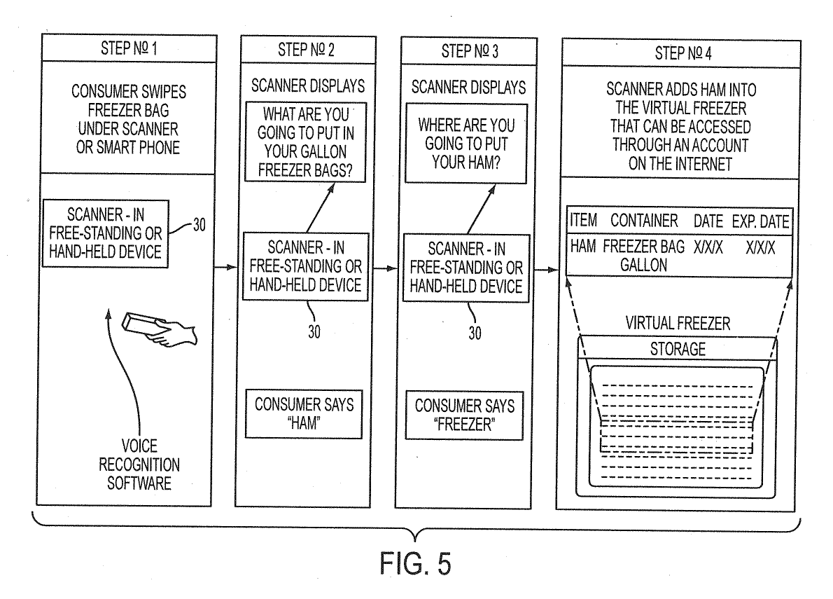

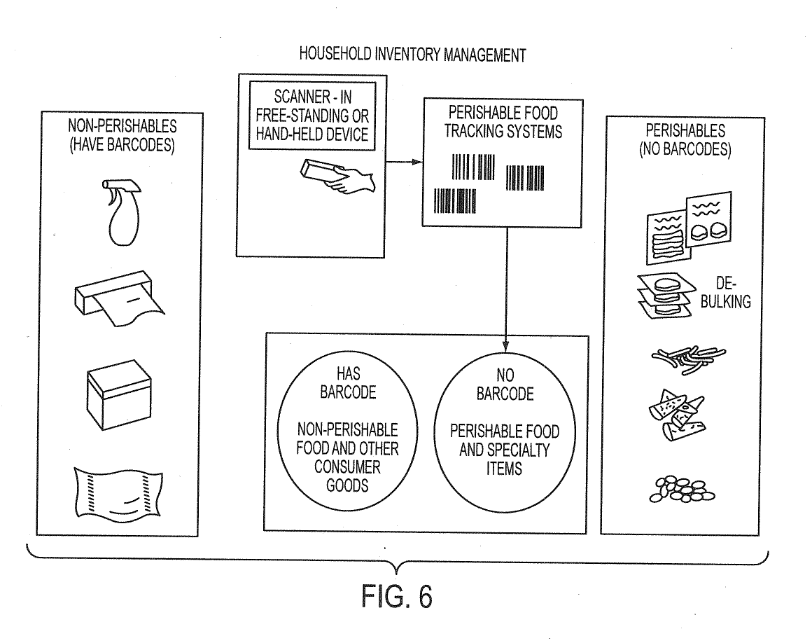

As shown in FIGS. 5 and 6, the product information is entered into the management system or application to carry out the method of the present disclosure using, preferably, a scanner 30. The scanner may be a free-standing or hand-held device. It may be an independent device or incorporated into another device. For example a smart phone with scanning ability is preferred or a commercially available scanner, such as the IKAN Food Scanner, can be used. The scanner 30 may be a personal scanner in the consumer's home or attached to a computer, a separate and free-standing scanner located in a grocery store, or a scanner located at the check-out line in the grocery store.

Product information may be entered by the scanner into the management system by scanning a conventional product barcode. The system or application reads or decodes the information provided by the barcode, including the product description, nutritional information and cost, and further provides a date of entry of information which can serve as the acquired date of the product and basis for future calculations, such as freshness level. Further, the scanner can include voice recognition software so that the consumer can insert the product information by speaking the description of the product. Also, the scanner or device in which it is contained can include a keypad for manually typing and entering the product information. The latter two methods of inserting product information are necessarily useful when a product does not have a barcode and/or when desiring to customize the management system with information not present on a manufacturer's barcode.

Further, as shown in FIG. 5, the consumer may modify products by placing them in different types and sizes of storage bags or containers. For example with respect to FIG. 5, a consumer may buy a family size package of a particular product, but divides the package into smaller portion sizes prior to storing. To make these packages, the consumer scans a barcode of a desired storage bag or container by the scanner 30 (Step No. 1). The scanner determines the size of the storage bag and then prompts the consumer to enter what type of product is going to be placed in the storage bag. The consumer speaks or enters the type of product, e.g., ham (Step No. 2). The scanner then prompts the consumer to enter the location where the product is going to be stored. The consumer speaks or enters where the product is to be stored, e.g., freezer (Step No. 3). The scanner then adds the product to the virtual storage location in the household product inventory, e.g., freezer (Step No. 4). The product information, including the product name, type of storage container, and purchase date, etc. is then stored and the management system will then calculate the expiration date based on the entered information.

The product information can then also be accessed through an Internet account on the consumer's computer, smart phone, PDA or other electronic means having or connected to with the system or application of the subject technology. Further, such packaging system may provide for product safeguards. For example, following step 3, the management system can advise whether the selected storage means is proper based on database information included in the management system. A specific example would be in the event a consumer decided to store mushrooms by vacuum packing the mushrooms. This is not a safe way to store mushrooms since mushrooms can contain spores of bacteria which continue to respire and thus the sealed package would become anaerobic after a few days following vacuum packaging. In this case, the management system would alert the consumer that this manner of packaging is not safe.

Once the product information is entered and accepted by the consumer, this information can be displayed to the consumer in various forms, such as shown, for example, in FIG. 4. This display shows that the consumer has products stored in the freezer, the refrigerator, the pantry, the basement, and the closet. Additional storage locations may also be provided. The consumer can then view a listing of all products stored in each location, including the type and size of container used to store the product, the date the product was added to the consumer's virtual storage, and the product's expiration date. The products can be sorted by expiration date and indicated, for example by icons such as 32A, 32B and 32C, as being ready for the trash (icon 32A), close to expiration (yield sign icon 32B) or are still good (OK icon 32C).

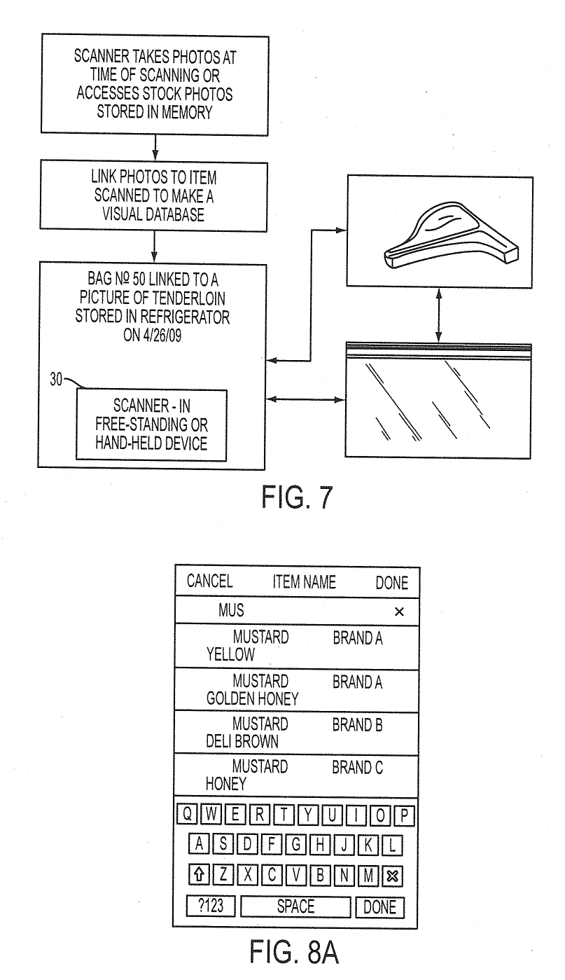

In another aspect of the disclosure, as shown for example in FIG. 7, when the consumer scans a product, the scanner takes a photograph of the product or accesses a stock photograph stored in the memory thereof. The photograph is then linked to the scanned product to make a visual database of the product. Also, when a consumer places a particular item in a storage bag as set forth above, the particular bag is assigned a number and the bag can also be linked with a picture of the product and the product information. For example, the product entered is a pork tenderloin and a picture of pork tenderloin is displayed with the following written description: Bag No. 50—pork tenderloin stored in refrigerator on Apr. 26, 2009. Other information such as the expiration date, serving size, quantity, store purchased from, etc. may also be displayed.

Further, when a product is used or is almost empty, the product barcode can be scanned so that this particular item will be removed from the household inventory and, if desired, added to the shopping list or other category.

Another aspect of the disclosure provides the consumer with a map of a grocery store and a particular route through the aisles that should be followed during shopping so that every item on the consumer's grocery list is obtained without the consumer have to backtrack through the store.

The product manufacturer's database can also be used to generate shopping lists by the consumer and can be linked with an online grocery store account on the consumer's computer for delivery of those selected items to the consumer in accordance with the online grocery store protocol.

Once product information is entered by selected means into the electronic device carrying out the application, other display screens are also available to the consumer on one or more of the consumer's electronic devices, e.g., computer or smart phone, containing the application. Additional features of the management method are available and depictable through particular display screens including, but not limited to:

Kitchen Alerts—the consumer receives a message when specific products are added to the grocery list and when a shopping trip is needed;

History—when shopping, items that are checked off are saved in the application history so the consumer can sort through the product history to quickly build the next shopping list, including staple items that are frequently used or that the consumer knows will be used prior to the next shopping trip;

Link/List Sharing—build and edit shopping lists that are shared with other family members, with real-time syncing so that all family members have the most current shopping lists; and

Favorites—provides a list of favorite foods, recipes, etc., and enables the consumer to create shopping lists from favorite foods so that items are not forgotten when the consumer is grocery shopping.

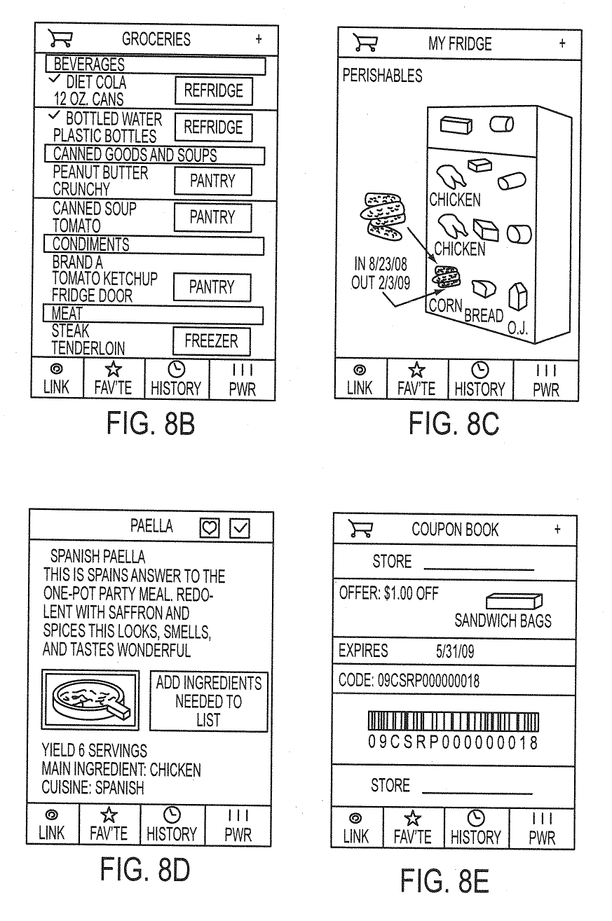

Examples of display screens are illustrated in FIGS. 8A-8E. For example, FIG. 8A shows a listing of various items fitting the description entered by the consumer. For example, when the consumer types “mus” or “mustard”, a listing of all the brands and styles of mustard (or foods starting with the letters inputted) in the consumer's virtual storage is displayed. The display can list brands previously purchased by the consumer and/or indicate only brands currently in the consumer's inventory and the status thereof.

FIG. 8B illustrates a consumer's groceries categorized by type of product, such as beverages, canned goods and soups, condiments and meat. A listing of the brand, size, description and location of each product in each category in the consumer's virtual storage is displayed.

FIG. 8C illustrates a display of the consumer's virtual refrigerator with the particular products with the purchase date and expiration date of each product.

FIG. 8D illustrates an aspect of the disclosure where the consumer can search for particular recipes online and the ingredients for such recipes are added to the consumer's shopping list generated by the application. Alternatively, a consumer can check their household inventory to determine if they have all the ingredients for a particular recipe. If all ingredients are not in the consumer's household inventory, the consumer can add these items to the grocery list of the system if they desire to go to the grocery store to purchase these missing ingredients or they can choose a different recipe for which all the ingredients are in the household inventory.

FIG. 8E illustrates a display of a coupon “book” containing coupons obtained from manufacturers' online sites using the present management system. The display includes the particular store the coupon is for if the coupon is so limited, the product description with discount or promotion, the expiration date, and the coupon barcode.

### Budget Category

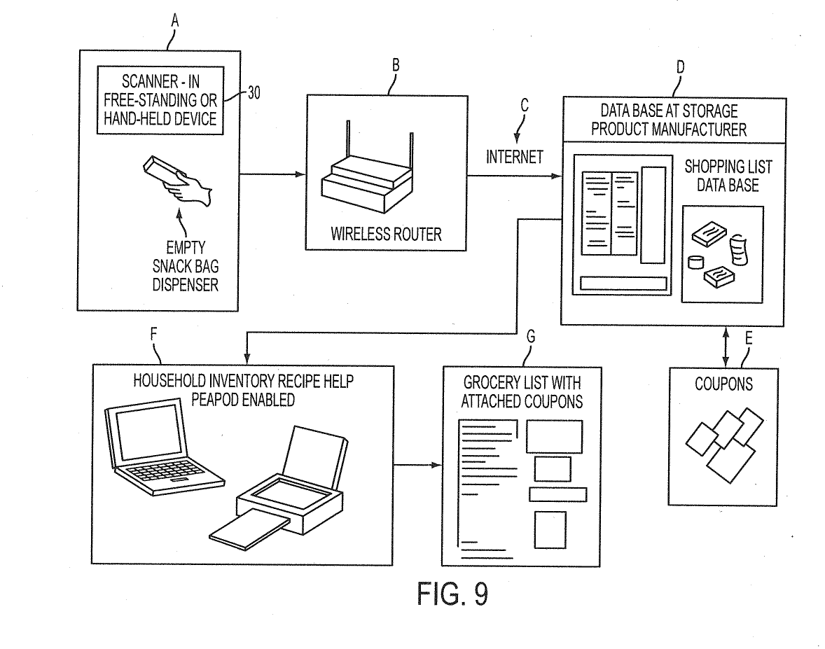

As shown in FIG. 9, when an empty product is scanned into the consumer's management system (A), the application carrying out the method can connect via a router (B) to the Internet (C) to a database (D) of the product's manufacturer to access and download consumer coupons (E) for the product. This enables a consumer to save time by not having to look for and clip coupons. The coupons can be printed on the consumer's computer or incorporated into the consumer's shopping list (F) and (G) for scanning of the coupon barcode at a store's checkout. When the empty product is scanned, it can manually or automatically be added to a grocery list so that the grocery list and coupons for products on the grocery list will be linked to these products and be available to the consumer when purchasing those products. The coupons obtained can be redeemed from a printout of the coupons as described above or by calling up an image of the coupon for display on a screen of the electronic device which can access the management system and scanning the barcode at the checkout from the screen. The accessible networks can be in the consumer's home, in a retail location, remote via cell tower and the like.

Further, the management system also enables the consumer to monitor prices for products purchased or on the shopping list in order to take advantage of periodic discounts on products routinely purchased. The consumer can be notified of price changes of products in their inventory and compare prices of various products or compare the price of a specific product in different stores. Also, the consumer can monitor their budget and expenses over a period of time or while shopping. For example, as each item is checked off the list as it is placed in the shopping cart, the system uses the stored product prices to keep a running total of the costs. Accordingly, on an immediate level the consumer is no longer surprised by the total at checkout, but knows the total grocery costs as they are shopping. On a planning or reporting level, the consumer can track receipts as to items that may have tax reporting consequences, e.g. medicines, prescriptions, or other applicable products. Further, the consumer can team up with other consumers to take advantage of bulk purchases offered at discount prices.

### Repertoire Category

The repertoire aspect of the subject technology enables the consumer to search for recipes based on various parameters including time, skill level, ingredients in household inventory and number of people. Further, the user can extend their repertoire of meals by searching for recipes using products that are on sale. The consumer can also make a database of favorite recipes or recipes for a particular time period, such as recipes for an entire week.

### Nutrition Category

The nutrition aspect of the subject technology enables the consumer to gain control over and manage long-term food issues including diet, weight, health, and medical conditions. By showing the consumer information about their food and grocery shopping history, consumers can make better decisions when they are shopping. Further, consumers can track whether a particular food is in compliance with a diet or medical conditions or restrictions.

More particularly, the system enables the consumer to obtain nutritional facts about the food purchased or consumed and show the consumer a history of the food consumed. Thus, the consumer can track the consumption of groceries over time and track the nutritional content of these groceries, including calories, cholesterol, sodium, carbohydrates, fat, sugar, etc. This is particularly beneficial in tracking one's daily caloric, cholesterol, sodium, carbohydrate, fat or sugar intake depending on the diet of the person. Further, the system can be used with other devices so the consumer can monitor specific medical conditions, such as diabetes and high blood pressure, based on their daily food consumption.

In another embodiment, the subject technology is applied to all the contents of a household. This application is particularly well-suited to be utilized when the consumer is moving from one location to another. The system further includes tags that allow container and items to be recognized and entered into the informational database. Further, upon entering a description, the item is cross-referenced to an informational database that can provide the consumer with information related to a proper container as well as coupons, purchase price, location and the like for such containers.

By cataloging all or a portion of the household items prior to moving, after moving, each items location may be presented to the consumer. Further, the system may provide display of an intended location at the new home so that the moving company or household members may determine a proper location to unload each item for unpacking. The system can also utilize photographs or video linking to allow the moving company to review the household contents remotely for providing advice, an estimate and the like for the moving project. Advice could include a packing material list that is then subsequently purchased on-line or reserved at a local retail location. The system can also provide recommendations for how to store various items such as disclosed in U.S. Provisional Patent Application No. 61/344,839 filed on Oct. 21, 2010, which is incorporated herein by reference. The tags for identifying object can include barcodes, RFID technology and the like so that the tagged items become smart products.

It is envisioned that the computers, scanners, electronic devices and such as is now known and later developed are each capable of supporting all the aspects of the subject technology. Each such appliance would typically have a central processor operatively connected to memory, which has an instruction set to accomplish the features, structures and steps necessary to accomplish using the subject technology.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

What is claimed is:

1. A method of managing products in a household inventory comprising:
inputting into an electronic device selected product information, including at least an acquisition date, for products in a household inventory to provide a product database;
storing the product database in a form so that the selected product information can be sorted and/or used to create new data to provide select information, including at least a freshness level, for each product in a virtual storage location; and
displaying in a readable electronic format the select information according to at least one of: the freshness level of each product, the virtual storage location of each product, or products sorted into pre-set categories.

2. The method of claim 1, wherein the selected product information further includes at least one of a mode of storage, product description, a product picture, an expiration date, and a storage location.

3. The method of claim 1, wherein the electronic device includes at least one of a scanner, a computer, a smart phone and personal digital assistant.

4. The method of claim 1, wherein the virtual storage location includes at least one of a refrigerator, freezer, pantry, basement or closet.

5. The method of claim 1, wherein the freshness level includes an indication of whether (1) a product is still fresh, (2) a product needs to be used within a pre-set time period or (3) a product has expired and needs to be thrown out.

6. The method of claim 1, further comprising generating a shopping list of products from said product database based on the freshness level of each product.

7. The method of claim 1, further comprising generating a shopping list of products from said product database based on whether a product is depleted from the household inventory.

8. The method of claim 1, further comprising generating at least one coupon for at least one product in the product database by interconnection via Internet to a product manufacturer's database.

9. The method of claim 1, further comprising generating at least one coupon for at least one product on a shopping list of products which has been generated from said product database based on expiration date of the product.

10. The method of claim 1, further comprising searching for a recipe or creating a recipe based on one or more products present in the product database.

11. The method of claim 1, wherein the inputting of the selected product information into said electronic device occurs by at least one of:
scanning a barcode of a product with a scanner device;
speaking a description of a product into a voice-recognition device;
manually entering a description of a product into the electronic device; or
photocopying a product or accessing a stock photograph of a product from a database and entering such into the electronic device.

12. The method of claim 1, further comprising managing one or more consumers diet based on a nutritional content of a plurality of products in the product database for a set time period.

13. The method of claim 1, further comprising tracking expenses of a plurality of products depleted from the product database within a pre-set time period.

14. The method of claim 1, further comprising tracking expenses of a plurality of products on a shopping list based on the product database.

15. The method of claim 1, further comprising tracking expenses of a plurality of products purchased over a selected time period.

16. A method of managing an inventory of household products comprising the steps of:
storing data related to a plurality of products, wherein the data includes a description of the products, a storage location of the product, a date the products were purchased, a cost of the products, an expiration date of the products, and a freshness level of the products based on age and manner of storage;
using a smart phone to access the data;
generating a shopping list based upon comparison of the data to ingredients of a recipe;
obtaining coupons for the ingredients; and
tracking grocery expenses, diet and food consumption based on the data when products are indicated as consumed by a user.

17. A method as recited in claim 16, wherein the data further includes a selected storage means, and the method further comprises the step of advising whether the selected storage means is proper.

18. A method as recited in claim 16, further comprising the steps of:
providing a map of a grocery store and a particular route through the grocery store to acquire the shopping list;
placing an order with an online grocery store for the shopping list; and
providing notice of price changes of products in the shopping list.

19. A method of managing an inventory of household products during a relocation comprising the steps of:
storing data related to a plurality of items in a first location, wherein the data includes a description of the products and a storage location of the product;
moving the plurality of items to a second location;
updating the data for the second location; and
providing the data related to a single item of the plurality of items based upon a request related to the single item by a consumer.

20. The method of claim 19, wherein the description includes a photograph.
